(19) United States
(12) Patent Application Publication
(10) Pub. No.: US 2008/0198310 A1
(43) Pub. Date: Aug. 21, 2008

(54) DISPLAY SUBSTRATE AND DISPLAY PANEL HAVING THE SAME

(75) Inventor: Hyun-Young Kim, Suwon-Si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 12/031,078

(22) Filed: Feb. 14, 2008

(30) Foreign Application Priority Data
Feb. 15, 2007 (KR) 2007-0016213

(51) Int. Cl. G02F 1/1335

(52) U.S. Cl. 349/106

(57) ABSTRACT

A display substrate includes a base substrate, a blocking portion formed on the base substrate dividing the base substrate into a plurality of pixel portions, wherein each of the pixel portions is divided into a reflective area and a transmissive area, a color filter layer formed in the pixel portions, and a distance maintaining member formed on the color filter layer in the reflective area.

### CROSS-REFERENCE TO RELATED APPLICATION

This application claims priority under 35 U.S.C. §119 to Korean Patent Application No. 2007-16213, filed on Feb. 15, 2007, the contents of which are herein incorporated by reference in their entirety.

### BACKGROUND OF THE INVENTION

1. Technical Field

The present disclosure relates to a display substrate and a display panel having the display substrate, and more particularly, to a display substrate and a display panel having the display substrate for enhancing stability of a manufacturing process and improving a reflection ratio.

2. Discussion of the Related Art

Generally, a display apparatus includes a display panel. The display panel includes an array substrate where switching elements are arrayed, a color filter substrate disposed opposite the array substrate, and a liquid crystal layer interposed between the array substrate and the color filter substrate. The display panel includes a column spacer to maintain a cell gap between the array substrate and the color filter substrate. The column spacer is formed in an area where lines and a switching element are formed, to enhance an aperture ratio of the display panel.

The display panel includes a transmissive type, a reflective type or a transflective type display panel according to a type of a light source. The transflective type display panel includes a cell gap between the array substrate and the color filter substrate in the reflective area different from a cell gap between the array substrate and the color filter substrate in the transmissive area. Due to the difference of the cell gap in the reflective area and in the transmissive area, a position of the column spacer is unstable, and a reflection ratio is decreased due to the column spacer.

### SUMMARY OF THE INVENTION

According to an exemplary embodiment of the present invention, a display substrate comprises a base substrate, a blocking portion formed on the base substrate dividing the base substrate into a plurality of pixel portions, wherein each of the pixel portions is divided into a reflective area and a transmissive area, a color filter layer formed in the pixel portions, and a distance maintaining member formed on the color filter layer in the reflective area.

The color filter layer may comprise a plurality of light holes exposing the base substrate.

The color filter layer may comprise a red color filter, a green color filter and a blue color filter.

The distance maintaining member can be formed on the blue color filter.

The display substrate may further comprise a common electrode formed on the color filter layer.

The distance maintaining member can be formed on the common electrode.

The display substrate may further comprise an organic layer pattern formed on the color filter layer in the reflective area.

The distance maintaining member can be formed on the organic layer pattern.

The distance maintaining member and the organic layer pattern can be patterned from a substantially same layer.

According to an exemplary embodiment of the present invention, a display panel comprises a first display substrate including a plurality of pixel portions, wherein each of the pixel portions has a transmissive area including a transmissive electrode and a reflective area including a reflective electrode, a second display substrate disposed opposite the first display substrate, wherein the second display substrate includes a color filter layer corresponding to the pixel portions and a distance maintaining member formed on the color filter layer corresponding to the reflective area, and a liquid crystal layer disposed between the first and second display substrates.

The color filter layer may comprise a plurality of light holes.

The color filter layer may comprise a red color filter, a green color filter and a blue color filter.

The distance maintaining member can be formed on the blue color filter.

The second display substrate may further comprise a common electrode formed on the color filter layer.

The liquid crystal layer may have a first cell gap corresponding to the reflective area, and a second cell gap corresponding to the transmissive area, and the second cell gap is larger than the first cell gap.

The first display substrate may further comprise a first organic layer pattern formed under the reflective electrode.

The second display substrate may further comprise a second organic layer pattern formed on the color filter layer in the reflective area.

The distance maintaining member can be formed on the second organic layer pattern.

The distance maintaining member and the second organic layer pattern can be patterned from a substantially same layer.

The first display substrate may further comprise an organic layer pattern that has an embossed shape and is disposed under the reflective electrode.

### BRIEF DESCRIPTION OF THE DRAWINGS

Exemplary embodiments of the present invention can be understood in more detail from the following descriptions taken in conjunction with the accompanying drawings, in which:

FIG. 1 is a plan view illustrating a display substrate according to an exemplary embodiment of the present invention;

FIG. 2 is a plan view illustrating a display panel including a display substrate according to an exemplary embodiment of the present invention;

FIG. 3 is a cross-sectional view taken along the line I-I′ of FIG. 2;

FIG. 4 is a cross-sectional view illustrating a display panel according to an exemplary embodiment of the present invention;

FIG. 5 is a cross-sectional view illustrating a display panel according to an exemplary embodiment of the present invention;

FIG. 6 is a plan view illustrating a display panel according to an exemplary embodiment of the present invention; and

FIG. 7 is a cross-sectional view taken along the line II-II′ and the line III-III′ of FIG. 6.

### DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

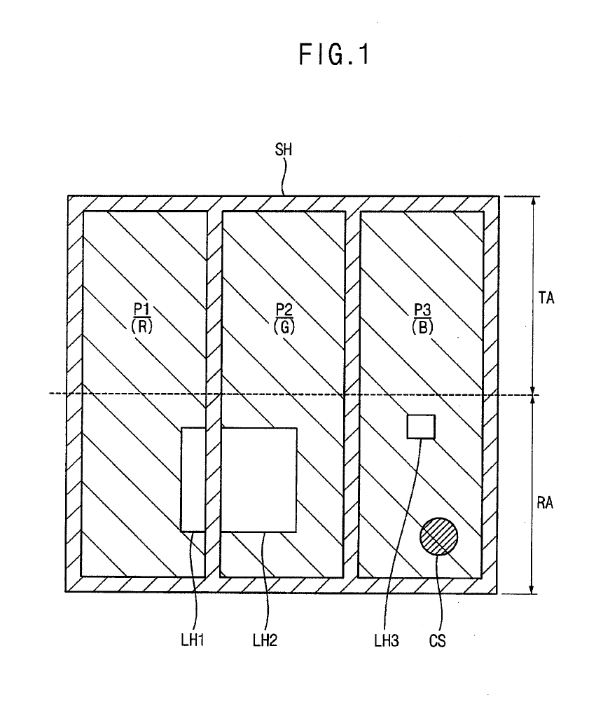

It will be understood that when an element or layer is referred to as being “on,” “connected to” or “coupled to” another element or layer, it can be directly on, connected or coupled to the other element or layer or intervening elements or layers may be present. FIG. 1 is a plan view illustrating a display substrate according to an exemplary embodiment of the present invention.

Referring to FIG. 1, the display substrate includes a blocking portion SH and a plurality of pixel portions P1, P2 and P3 divided by the blocking portion SH.

The blocking portion SH includes an opaque material blocking light, to divide the display substrate into a transmitting area and a blocking area. In an exemplary embodiment, the display substrate may not include the blocking portion SH.

The transmitting area divided by the blocking portion SH includes the plurality of the pixel portions P1, P2 and P3. For example, the transmitting area includes the first pixel portion P1 where a first color (red) filter R is formed, the second pixel portion P2 where a second color (green) filter G is formed, and the third pixel portion P3 where a third color (blue) filter B is formed.

Each of the first, second and third pixel portions P1, P2 and P3 is divided into a transmissive area TA and a reflective area RA.

A portion of the first color filter R corresponding to the reflective area RA of the first pixel portion P1 is removed to form a first light hole LH1 having a first size. A portion of the second color filter G corresponding to the reflective area RA of the second pixel portion P2 is removed to form a second light hole LH2 having a second size. A portion of the third color filter B corresponding to the reflective area RA of the third pixel portion P3 is removed to form a third light hole LH3 having a third size. A distance maintaining member CS is formed on the third color filter B.

The first, second and third light holes LH1, LH2 and LH3 are formed, for example, to enhance color reproducibility. The sizes of the first, second and third light holes LH1, LH2 and LH3 are determined based on the color reproducibility of the red, green and blue colors.

For example, the second light hole LH2 of the second pixel portion P2 is larger than the first light hole LH1 of the first pixel portion P1. The first light hole LH1 is larger than the third light hole LH3 of the third pixel portion P3.

The distance maintaining member CS is formed on the third color filter B, to maintain a distance between the display substrate and a substrate combined with the display substrate.

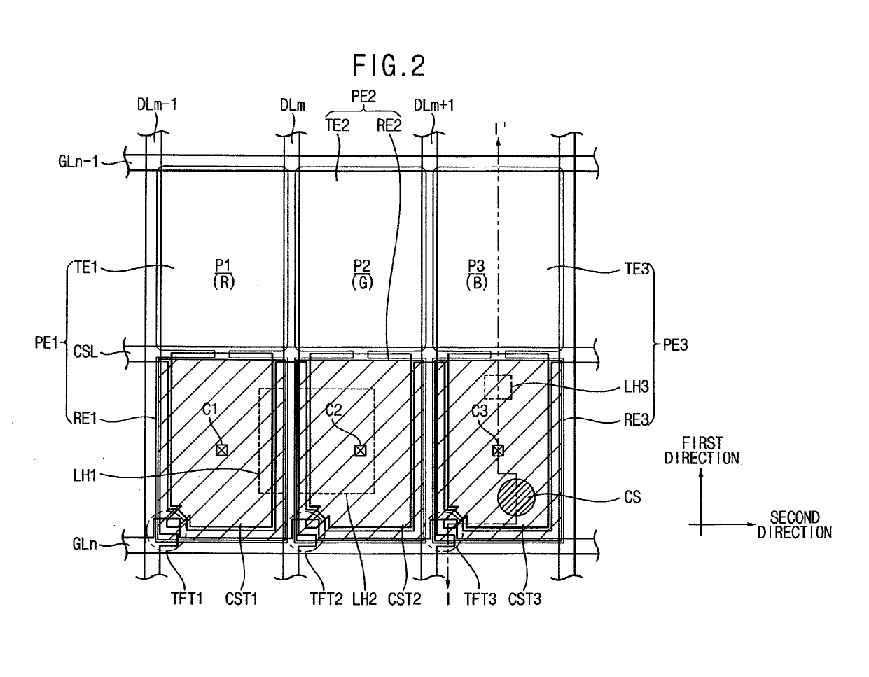

FIG. 2 is a plan view illustrating a display panel including a display substrate according to an exemplary embodiment of the present invention.

Referring to FIGS. 1 and 2, the display panel includes a first display substrate, a second display substrate combined with the first display substrate, and a liquid crystal layer disposed between the first and second display substrates.

The first display substrate includes source lines DLm−1, DLm and DLm+1 extending along a first direction, gate lines GLn−1 and GLn extending along a second direction substantially perpendicular to the first direction, and the first, second and third pixel portions P1, P2 and P3. Each of the first, second and third pixel portions P1, P2 and P3 is divided into the transmissive area TA and the reflective area RA.

The first pixel portion P1 includes a first switching element TFT1 electrically connected to the (m−1)-th source line DLm−1 and the n-th gate line GLn, a first storage capacitor CST1 electrically connected to a storage common line CSL, and a first pixel electrode PE1 electrically connected to the first switching element TFT1. The first pixel electrode PE1 is electrically connected to the first switching element TFT1 through a first contact portion C1, and includes a first transmissive electrode TE1 and a first reflective electrode RE1. The first switching element TFT1, the first storage capacitor CST1 and the first reflective electrode RE1 are formed in the reflective area RA of the first pixel portion P1. The first transmissive electrode TE1 is formed in the transmissive area TA of the first pixel portion P1.

The second pixel portion P2 includes a second switching element TFT2 electrically connected to the m-th source line DLm and the n-th gate line GLn, a second storage capacitor CST2 electrically connected to the storage common line CSL, and a second pixel electrode PE2 electrically connected to the second switching element TFT2. The second pixel electrode PE2 is electrically connected to the second switching element TFT2 through a second contact portion C2, and includes a second transmissive electrode TE2 and a second reflective electrode RE2. The second switching element TFT2, the second storage capacitor CST2 and the second reflective electrode RE2 are formed in the reflective area RA of the second pixel portion P2. The second transmissive electrode TE2 is formed in the transmissive area TA of the second pixel portion P2.

The third pixel portion P3 includes a third switching element TFT3 electrically connected to the (m+1)-th source line DLm+1 and the n-th gate line GLn, a third storage capacitor CST3 electrically connected to the storage common line CSL, and a third pixel electrode PE3 electrically connected to the third switching element TFT3. The third pixel electrode PE3 is electrically connected to the third switching element TFT3 through a third contact portion C3, and includes a third transmissive electrode TE3 and a third reflective electrode RE3. The third switching element TFT3, the third storage capacitor CST3 and the third reflective electrode RE3 are formed in the reflective area RA of the third pixel portion P3. The third transmissive electrode TE3 is formed in the transmissive area TA of the third pixel portion P3.

The second display substrate includes the first, second and third color filters R, G and B corresponding to the first, second and third pixel portions P1, P2 and P3, respectively. The distance maintaining member CS is formed on the third color filter B to maintain a distance between the first and second display substrates.

For example, the second display substrate may further include a common electrode (not shown) facing the first, second and third pixel electrodes PE1, PE2 and PE3, and the blocking portion SH corresponding to the source lines DLm−1, DLm and DLm+1 and gate lines GLn−1 and GLn.

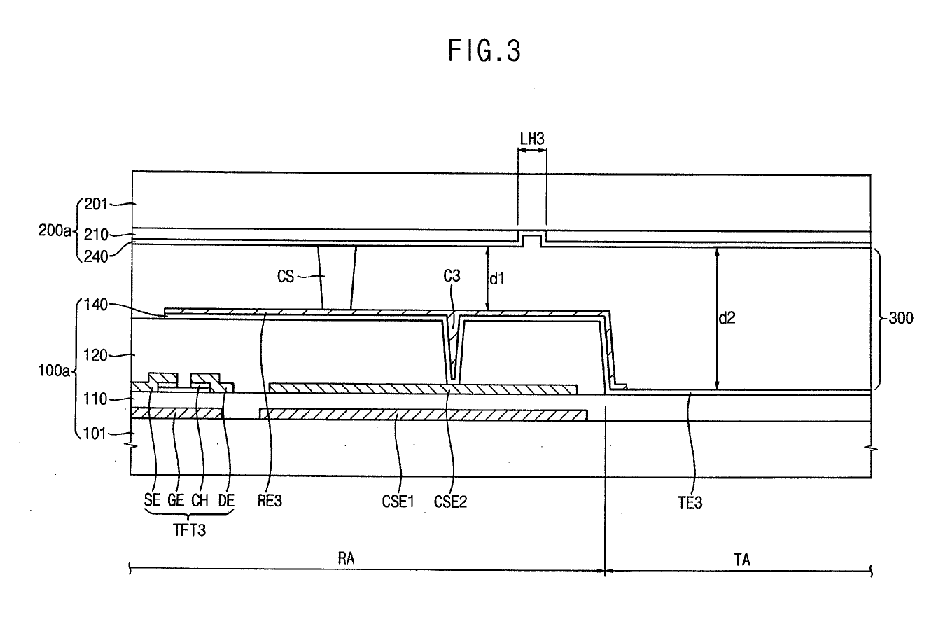

FIG. 3 is a cross-sectional view taken along the line I-I′ of FIG. 2.

Referring to FIGS. 2 and 3, the display panel according to an exemplary embodiment of the present invention includes a first display substrate 100a, a second display substrate 200a and a liquid crystal layer 300.

The first display substrate 100a includes a first base substrate 101. A gate metal pattern including the gate lines GLn−1 and GLn, a gate electrode GE, the storage common line CSL and a storage common electrode CSE1 extending from the storage common line CSL, is formed from a gate metal layer on the first base substrate 101. A gate insulating layer 110 is formed on the base substrate 101, on which the gate metal pattern is formed.

A channel portion CH overlapping the gate electrode GE is formed on the gate insulating layer 110. The channel portion CH includes an active layer including amorphous silicon (a-Si) and an ohmic contact layer including an amorphous silicon doped with N+ ions at a high concentration (n+a-Si).

A source metal pattern including the source lines DLm−1, DLm and DLm+1, a source electrode SE, a drain electrode DE and a storage electrode CSE2 electrically connected to the drain electrode DE, is formed from a source metal layer on the first base substrate 101. Thus, the switching element and the storage capacitor are formed. For example, the third switching element TFT3 and the third storage capacitor CST3 are formed in the third pixel portion P3.

A photosensitive organic insulating layer (“organic insulating layer”) is formed on the first base substrate 101 on which the source metal pattern is formed, and an organic layer pattern 120 is formed in the reflective area RA via patterning the organic insulating layer. Accordingly, the organic layer pattern 120 forms a stepped portion between the reflective area RA and the transmissive area TA, and the stepped portion causes the liquid crystal layer 300 to have a multi-cell gap.

A transparent conductive layer is formed on the base substrate 101 on which the organic layer pattern 120 is formed. Transparent electrode patterns correspond to the first, second and third pixel portions P1, P2 and P3, respectively, via patterning the transparent conductive layer.

For example, a transparent electrode pattern 140 formed in the transmissive area TA of the third pixel portion P3 may be the transmissive electrode TE3 of the third pixel portion P3. The third contact portion C3 is formed through the organic layer pattern 120, to electrically connect the drain electrode DE with the transparent electrode pattern 140.

A reflective metal layer including a metal material having a good reflection ratio, such as silver (Ag) and silver-molybdenum (Ag—Mo: AMO), is formed on the transparent electrode pattern 140. The reflective metal layer is patterned to form the third reflective electrode RE3 in the reflective area RA. The third reflective electrode RE3 is electrically connected to the transparent electrode pattern 140. The third pixel electrode PE3 of the third pixel portion P3 includes the third transmissive electrode TE3 and the third reflective electrode RE3.

The second display substrate 200a includes a second base substrate 201. A color filter layer 210, a common electrode 240 and the distance maintaining member CS are formed on the second base substrate 201.

The first, second and third color filters R, G and B are formed in the color filter layer 210, to respectively correspond to the first, second and third pixel portions P1, P2 and P3 of the first display substrate 100a. The color filter layer. 210 includes the first, second and third light holes LH1, LH2 and LH3.

The first light hole LH1 having the first size, corresponds to the reflective area RA of the first pixel portion P1. The second light hole LH2 having the second size, corresponds to the reflective area RA of the second pixel portion P2. The third light hole LH3 having the third size, corresponds to the reflective area RA of the third pixel portion P3. In an exemplary embodiment, the first, second and third light holes LH1, LH2 and LH3 may have various sizes according to the color reproducibility, and may not be formed in the pixel portion P3 where the blue color filter is formed.

The common electrode 240 is formed on the color filter layer 210, to face the first, second and third pixel electrodes PE1, PE2 and PE3 of the first display substrate 100a.

The distance maintaining member CS is formed in the reflective area RA of the third pixel portion P3 in which the blue color filter B is formed. In FIGS. 2 and 3, a blue portion of the reflection ratio, which is contributed by the blue color filter B, is smallest among red, green and blue portions corresponding to the first, second and third pixel portions P1, P2 and P3, respectively. The distance maintaining member CS is formed in the flat reflective area RA, so that the distance maintaining member CS may be stably disposed.

Therefore, according to an exemplary embodiment of the present invention, the distance maintaining member CS is disposed in the pixel portion instead of being disposed in an area where the lines and the switching elements are formed. The first and second display substrates 100a and 200a are disposed in the flat area, so that a manufacturing process for the display panel may be stabilized.

The liquid crystal layer 300 is disposed between the first and second display substrates 100a and 200a. The organic layer pattern 120 is formed on the first display substrate 100a, so that the cell gap of the liquid crystal layer 300 in the reflective area RA is different from that of the liquid crystal layer 300 in the transmissive area TA. For example, the liquid crystal layer 300 in the reflective area RA has a first cell gap d1, and the liquid crystal layer 300 in the transmissive area TA has a second cell gap d2 larger than the first cell gap d1.

First light having passed through the second display substrate 200a, firstly passes through the liquid crystal layer 300 of the first cell gap d1 in the reflective area RA and is reflected from the third reflective electrode RE3. The reflected first light then secondly passes through the liquid crystal layer 300 of the first cell gap d1 in the reflective area RA. However, second light having passed through the first display substrate 100a, firstly passes through the liquid crystal layer 300 of the second cell gap d2 in the transmissive area TA. Thus, according to an exemplary embodiment of the present invention, the second cell gap d2 may be about twice as large as the first cell gap d1.

The distance maintaining member CS is formed in the third pixel portion P3, and thus, the number of liquid crystal molecules arranged in the third pixel portion P3 is less than the number of liquid crystal molecules arranged in the first and second pixel portions P1 and P2. In FIGS. 2 and 3, the optical characteristics of the blue color contributes relatively less than the red and green colors to the reflection ratio. Thus, although the number of the liquid crystal molecules arranged in the third pixel portion P3 corresponding to the blue color is decreased, the reflection ratio may not be decreased.

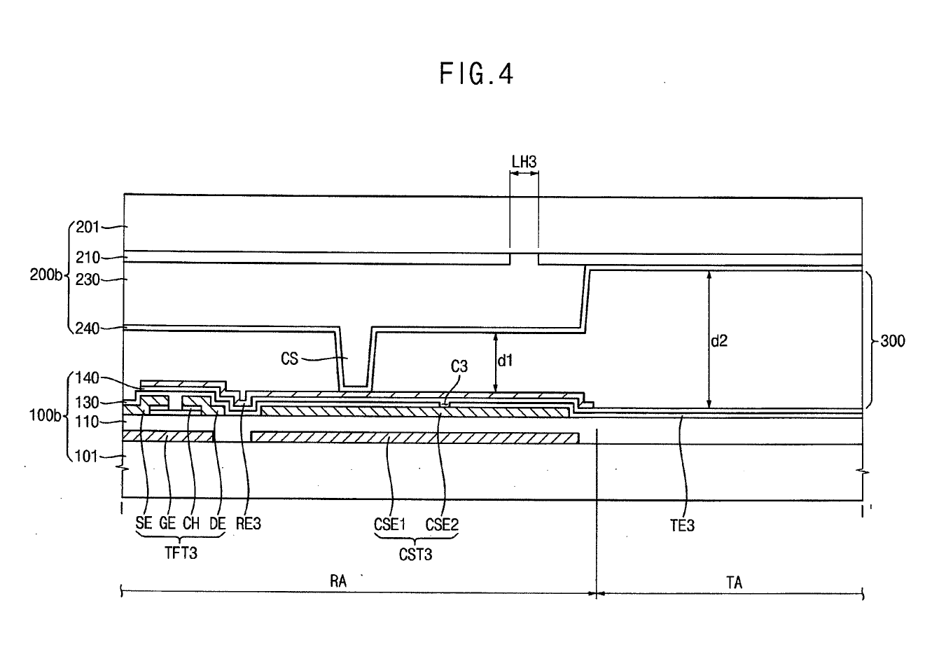

FIG. 4 is a cross-sectional view illustrating a display panel according to an exemplary embodiment of the present invention.

Referring to FIGS. 2 and 4, the display panel includes a first display substrate 100b, a second display substrate 200b and the liquid crystal layer 300.

The first display substrate 100b includes a first base substrate 101. The gate metal pattern including the gate lines GLn−1 and GLn, the gate electrode GE, the storage common line CSL and the storage common electrode CSE1, is formed from the gate metal layer on the first base substrate 101. The gate insulating layer 101 is formed on the gate metal pattern.

The channel portion CH overlapping the gate electrode GE is formed on the gate insulating layer 110. The source metal pattern including the source lines DLm−1, DLm and DLm+1, the source electrode SE, the drain electrode DE and the storage electrode CSE2 electrically connected to the drain electrode DE, is formed from the source metal layer on the first base substrate 101 on which the channel portion CH is formed. Accordingly, for example, the third switching element TFT3 and the third storage capacitor CST3 are formed in the third pixel portion P3.

A passivation layer 130 is formed on the first base substrate 101 on which the source metal pattern is formed. The transparent electrode pattern 140 is formed on the passivation layer 130, so that the third transmissive electrode TE3 is formed in the transmissive area TA.

The third reflective electrode RE3 is formed in the reflective area RA from a reflective metal layer on the transparent electrode pattern 140. Thus, the third pixel electrode PE3 including the third transmissive electrode TE3 and the third reflective electrode RE3 is formed. The third switching element TFT3 are electrically connected to the transparent electrode pattern 140 through the third contact portion C3 formed through the passivation layer 130.

The second display substrate 200b includes the second base substrate 201. The color filter layer 210, the organic layer pattern 230, the common electrode 240 and the distance maintaining member CS are formed on the second base substrate 201.

The organic insulating layer is formed on the color filter layer 210. The organic layer pattern 230 is formed in the reflective area RA via patterning the organic insulating layer, and then the distance maintaining member CS is formed on the organic layer pattern 230. The organic layer pattern 230 forms the stepped portion between the reflective area RA and the transmissive area TA, and thus the stepped portion causes the liquid crystal layer 300 to have a multi-cell gap.

In an exemplary embodiment of the present invention, the organic layer pattern 230 and the distance maintaining member CS are formed via substantially the same photosensitive organic insulating layer. Alternatively, the organic layer pattern 230 and the distance maintaining member CS may be formed from different layers.

The common electrode 240 is formed on the second base substrate 201 on which the organic layer pattern 230 and the distance maintaining member CS are formed. In an exemplary embodiment of the present invention, the common electrode 240 is formed on the distance maintaining member CS. In an exemplary embodiment, when the organic layer pattern 230 and the distance maintaining member CS are formed from the different organic insulating layers, the common electrode 240 may be formed on the color filter layer 210 and the organic layer pattern 230 and the distance maintaining member CS may be formed on the common electrode 240.

The distance maintaining member CS is formed in the reflective area RA of the third pixel portion P3 that has a relatively low contribution to the reflection ratio among the first, second and third pixel portions P1, P2 and P3. The distance maintaining member CS is formed in the flat reflective area RA, so that the distance maintaining member CS may be stably disposed. The distance maintaining member CS is disposed in the flat areas of the first and second display substrates 100b and 200b, so that a manufacturing process for the display panel may be stabilized.

The liquid crystal layer 300 is disposed between the first and second display substrates 100b and 200b. The organic layer pattern 230 is formed on the second display substrate 100b, so that the cell gap of the liquid crystal layer 300 in the reflective area RA is different from that of the liquid crystal layer 300 in the transmissive area TA. For example, the liquid crystal layer 300 in the reflective area RA has the first cell gap d1, and the liquid crystal layer 300 in the transmissive area TA has the second cell gap d2 larger than the first cell gap d1.

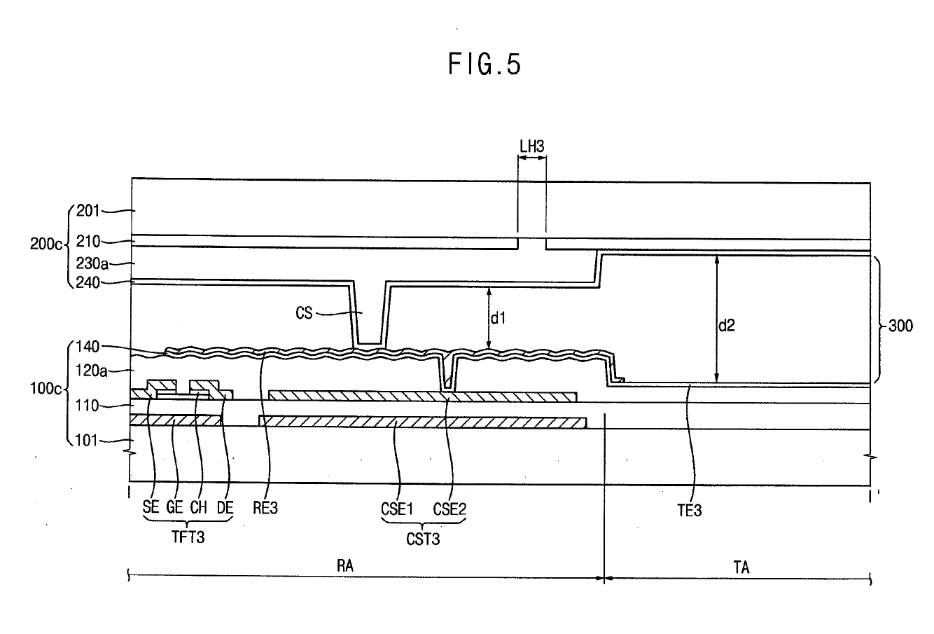

FIG. 5 is a cross-sectional view illustrating a display panel according to an exemplary embodiment of the present invention.

Referring to FIGS. 2 and 5, the display panel includes a first display substrate 100c, a second display substrate 200c and the liquid crystal layer 300.

The first display substrate 100c includes the first base substrate 101. The gate metal pattern including the gate lines GLn−1 and GLn, the gate electrode GE, the storage common line CSL and the storage common electrode CSE1 is formed from a gate metal layer on the first base substrate 101. The gate insulating layer 110 is formed on the first base substrate 101 on which the gate metal pattern is formed. The channel portion CH is formed on the gate insulating layer 110. The channel portion CH overlaps the gate electrode GE.

The source metal pattern including the source lines DLm−1, DLm and DLm+1, the source electrode SE, the drain electrode DE and the storage electrode CSE2 electrically connected to the drain electrode DE is formed from the source metal layer on the first base substrate 101 on which the channel portion CH is formed. Accordingly, the third switching element TFT3 and the third storage capacitor CST3 are formed in the third pixel portion P3.

The organic insulating layer is formed on the first base substrate 101 on which the source metal pattern is formed. A first organic layer pattern 120a having an embossed shape in the reflective area RA and the flat shape in the transmissive area TA, is formed via patterning the organic insulating layer.

The transparent conductive layer is formed on the first organic layer pattern 120a, and the transparent electrode patterns are formed via patterning the transparent conductive layer. The transparent electrode pattern 140 formed in the third pixel portion P3 has the embossed shape in the reflective area RA and the flat shape in the transmissive area TA, according to the surface shape of the first organic layer pattern 120a. The transparent electrode pattern 140 formed in the transmissive area TA may be the third transmissive electrode TE3.

The third reflective electrode RE3 is formed from the reflective metal layer, to correspond to the transparent electrode pattern 140 in the reflective area RA. The third reflective electrode RE3 is formed on the first organic layer pattern 120a having the embossed shape, so that the third reflective electrode RE3 has the embossed shape. Thus, the reflection ratio may be enhanced.

The second display substrate 200c includes the second base substrate 201. The color filter layer 210, the second organic layer pattern 230a, the common electrode 240 and the distance maintaining member CS are formed on the second base substrate 201.

The organic insulating layer is formed on the color filter layer 210, and the second organic layer pattern 230a is formed in the reflective area RA via patterning the organic insulating layer. The distance maintaining member CS is then formed on the second organic layer pattern 230a. The second organic layer pattern 230a forms the stepped portion between the reflective area RA and the transmissive area TA, and thus the stepped portion causes the liquid crystal layer 300 to have a multi-cell gap.

The common electrode 240 is formed on the second organic layer pattern 230a and the distance maintaining member CS. The common electrode 240 is formed opposite the third pixel electrode PE3.

The distance maintaining member CS is formed in the reflective area RA of the third pixel portion P3. For example, the third pixel portion P3 corresponds to the blue color pixel having a relatively low contribution to the reflection ratio. The distance maintaining member CS is formed in the flat reflective area RA, so that the distance maintaining member CS may be stably disposed. The distance maintaining member CS is disposed in the flat area of the first and second display substrates 100c and 200c, so that a manufacturing process for the display panel may be stabilized.

The liquid crystal layer 300 is disposed between the first and second display substrates 100c and 200c. The second organic layer pattern 230a is formed on the second display substrate 200c, so that the cell gap of the liquid crystal layer 300 in the reflective area RA is different from that of the liquid crystal layer 300 in the transmissive area TA.

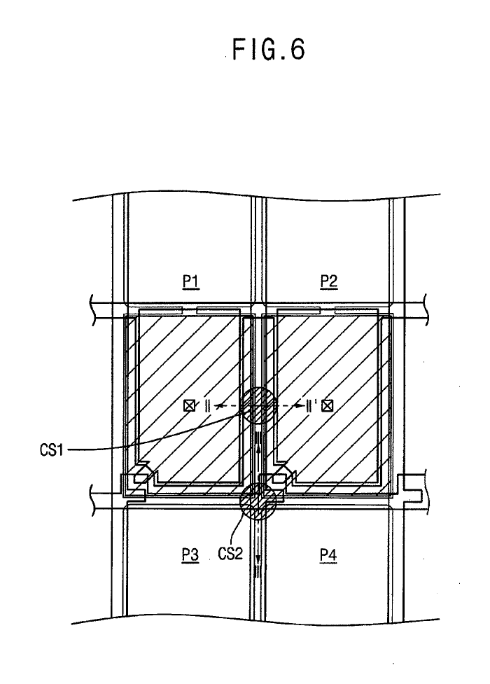

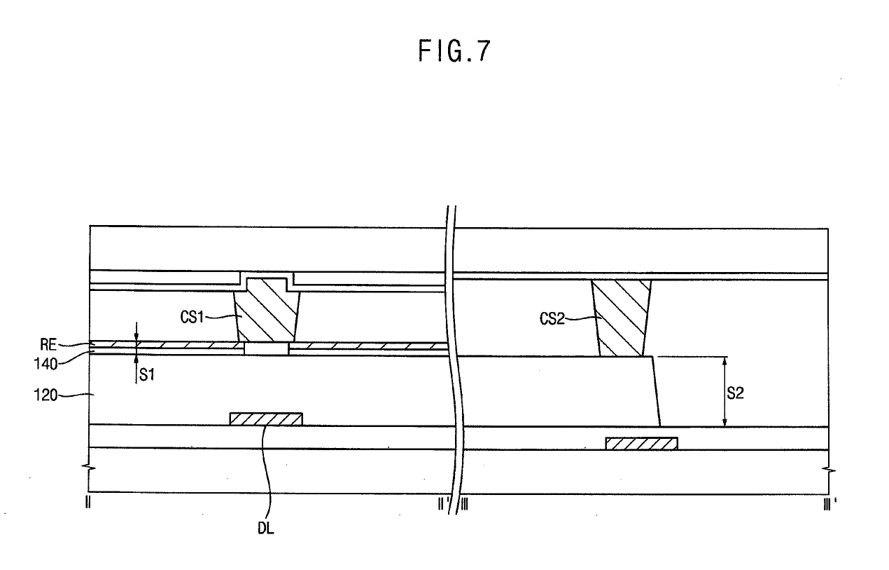

FIG. 6 is a plan view illustrating a display panel according to an exemplary embodiment of the present invention. FIG. 7 is a cross-sectional view taken along the line II-II′ and the line III-III′ of FIG. 6.

Referring to FIGS. 6 and 7, the display panel includes a first distance maintaining member CS1 and a second distance maintaining member CS2. The first distance maintaining member CS1 is disposed on a source line DL between the first and second pixel portions P1 and P2 adjacent to each other. The second distance maintaining member CS2 is disposed in an area where the switching element TFT is formed.

The stepped portion is formed by the transparent electrode pattern 140 and the reflective electrode RE formed in the reflective area RA of the first and second pixel portions P1 and P2. The first distance maintaining member CS1 is disposed in an area where the stepped portion is formed.

The second distance maintaining member CS2 is disposed in a border portion between the reflective area RA of the first and second pixel portions P1 and P2 and the transmissive area TA of the third and fourth pixel portions P3 and P4 adjacent to the reflective area RA of the first and second pixel portions P1 and P2. Accordingly, the organic layer pattern 120 forms a stepped portion S1 between the reflective area RA and the transmissive area TA, and thus the liquid crystal layer has a multi-cell gap.

When the first and second distance maintaining members CS1 and CS2 are disposed in an area where a stepped portion S2 is formed, and the first and second distance maintaining members CS1 and CS2 are shifted by an external pressure, the stepped portion S1 and S2 may prevent the first and second distance maintaining members CS1 and CS2 from being restored. Accordingly, the stability of a manufacturing process for the display panel may be deteriorated and light leakage may occur.

However, in an exemplary embodiment of the present invention, the distance maintaining member is formed in the flat reflective area of the pixel portion, and thus the manufacturing process for the display panel may be stabilized and the light leakage may be prevented.

Table 1 represents a loss of the reflection ratio between two exemplary embodiments of the present invention.

TABLE 1

| | Example 1 | | | Example 4 | | |
|---|---|---|---|---|---|---|
| | (CS in blue pixel) | | | (CS on DL between G and B pixels) | | |
| | | Area ratio | Loss of | | Area ratio | Loss of |
| | | (CS/ | reflection ratio | | (CS/ | reflection ratio |
| | Area | reflective area) | (R:G:B = 43.8:47.7:8) | Area | reflective area) | (R:G:B = 43.8:47.7:8) |
| Reflection | 3000 | 0.03768 | 8 × 3.8% = 0.304% | 3000 | 0.00684 | (47.7 × 0.684%) + (8 × 0.684%) = 0.38098% |
| area | | | | | | |
| CS | 113.04 | | | 20.52 | | |

Referring to Table 1, the display panel of Example 1 includes the distance maintaining member CS disposed in the reflective area of the blue pixel portion. In Table 1, the area of the reflective area of the blue pixel portion B and the area of the distance maintaining member CS were about 3,000 and about 113.04, respectively, and the loss of the reflection ratio was calculated.

An area ratio between the area of the distance maintaining member CS and the area of the reflective area was about 0.03768. Generally, the contribution of the red, green and blue pixel portions R, G and B to obtain the reflection ratio of about 99.5%, was about R:G:B=43.8%:47.7%:8%. Thus, the loss. of the reflection ratio in the blue pixel portion B was about 0.304%.

The display panel of Example 4 includes the distance maintaining member CS disposed on the source line DL between the green pixel portion G and the blue pixel portion B. In Table 1, the area of the distance maintaining member CS overlapping the reflective area of the green pixel portion G and the blue pixel portion B was about 20.52, and the loss of the reflection ratio was calculated.

The area ratio between the area of the distance maintaining member CS and the area of the reflective area was about 0.00648. Thus, the loss of the reflection ratio in the green pixel portion G and the blue pixel portion B was about 0.38098%.

According to Table 1, the loss of the reflection ratio according to Example 1 was less than that of the reflection ratio according to Example 4. Thus, the distance maintaining member CS is formed in the reflective area of the blue B pixel portion, so that the reflection ratio may be enhanced.

According to an exemplary embodiment of the present invention, a distance maintaining member is formed in a reflective area of a pixel portion, so that a manufacturing process for a display panel may be stabilized.

The distance maintaining member is formed in the reflective area of the pixel portion that has a relatively low contribution to a reflection ratio, so that the reflection ratio of the display panel may be enhanced.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A display substrate comprising:
a base substrate;
a blocking portion formed on the base substrate dividing the base substrate into a plurality of pixel portions, wherein each of the pixel portions is divided into a reflective area and a transmissive area;
a color filter layer formed in the pixel portions; and
a distance maintaining member formed on the color filter layer in the reflective area.

2. The display substrate of claim 1, wherein the color filter layer comprises a plurality of light holes exposing the base substrate.

3. The display substrate of claim 1, wherein the color filter layer comprises a red color filter, a green color filter and a blue color filter.

4. The display substrate of claim 3, wherein the distance maintaining member is formed on the blue color filter.

5. The display substrate of claim 1, further comprising a common electrode formed on the color filter layer.

6. The display substrate of claim 5, wherein the distance maintaining member is formed on the common electrode.

7. The display substrate of claim 5, further comprising an organic layer pattern formed on the color filter layer in the reflective area.

8. The display substrate of claim 7, wherein the distance maintaining member is formed on the organic layer pattern.

9. The display substrate of claim 8, wherein the distance maintaining member and the organic layer pattern are patterned from a substantially same layer.

10. A display panel comprising:
a first display substrate including a plurality of pixel portions, wherein each of the pixel portions has a transmissive area including a transmissive electrode and a reflective area including a reflective electrode;
a second display substrate disposed opposite the first display substrate, wherein the second display substrate includes a color filter layer corresponding to the pixel portions and a distance maintaining member formed on the color filter layer corresponding to the reflective area; and
a liquid crystal layer disposed between the first and second display substrates.

11. The display panel of claim 10, wherein the color filter layer comprises a plurality of light holes.

12. The display panel of claim 10, wherein the color filter layer comprises a red color filter, a green color filter and a blue color filter.

13. The display panel of claim 12, wherein the distance maintaining member is formed on the blue color filter.

14. The display panel of claim 10, wherein the second display substrate further comprises a common electrode formed on the color filter layer.

15. The display panel of claim 10, wherein the liquid crystal layer has a first cell gap corresponding to the reflective area, and a second cell gap corresponding to the transmissive area, and the second cell gap is larger than the first cell gap.

16. The display panel of claim 15, wherein the first display substrate further comprises a first organic layer pattern formed under the reflective electrode.

17. The display panel of claim 15, wherein the second display substrate further comprises a second organic layer pattern formed on the color filter layer in the reflective area.

18. The display panel of claim 17, wherein the distance maintaining member is formed on the second organic layer pattern.

19. The display panel of claim 18, wherein the distance maintaining member and the second organic layer pattern are patterned from a substantially same layer.

20. The display panel of claim 17, wherein the first display substrate further comprises an organic layer pattern that has an embossed shape and is disposed under the reflective electrode.
